(19) United States
(12) Patent Application Publication
(10) Pub. No.: US 2002/0145265 A1
(43) Pub. Date: Oct. 10, 2002

(54) Load distributing arrangement for a vehicle

(76) Inventor: Gerald Peter Howard, Welkom (ZA)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/827,337

(22) Filed: Apr. 4, 2001

(51) Int. Cl. B60R 3/00; E01B 23/00

(52) U.S. Cl. 280/163; 238/14

(57) ABSTRACT

The load distributing arrangement includes a load distributing member of the type described which is configured to define a running board for a vehicle, and a mounting apparatus for removably mounting the load distributing member in position on the vehicle so that the load distributing member serves as a running board, in use. The load distributing member may be formed of a plurality of steel channel sections attached to one another in a side-by-side relation, and the sides of the channel sections may form reinforcing ribs to inhibit deformation of the of the load distributing member, in use. The steel channel sections may include perforations to inhibit slipping of persons standing on the load distributing member, and to provide purchase for tires of a vehicle, when the load distributing member is used in its application as a sand ladder. The mounting apparatus may include a steel frame which may be bolted to the chassis of the vehicle to extend laterally from the vehicle body to define a platform for supporting the load distributing member, and may include one or more releasable fasteners, by which the channel sections may be attached to the frame, with the ribs of the channel sections orientated downwards. A fascia may also be attached to a free end of the frame, and one or more mud flaps may be attached to either one or both front and rear facing ends of the frame.

### BACKGROUND OF THE INVENTION

This invention relates generally to a load distributing arrangement. In particular, the invention relates to a load distributing arrangement for a vehicle.

It is known to use a load distributing device with a vehicle to assist in extricating the vehicle from sand, mud, and the like. When a vehicle is stuck in sand, mud, or the like, one or more wheels of the vehicle may lose traction. Then a load distributing device, such as a rigid planar member, may be inserted under such a vehicle wheel which has lost traction. The load distributing device distributes the mass of the vehicle over a relatively wide area, thereby assisting in the recovery of traction by the wheel, and permitting the vehicle to be extricated. Further, where it is intended that the load distributing device may be used repeatedly, it is desirable that the load distributing device should be of a sufficiently robust construction to support a substantial proportion of the mass of the vehicle without being damaged or inelastically distorted. Such a load distributing device is known as a “sand ladder” and is referred to hereafter in this specification as “a load distributing means of the type described.” In addition, storage of such load distributing devices in a vehicle can be problematic. It would also be desirable to provide a load distributing arrangement allowing for useful storage of the load distributing device in a vehicle when the load distributing device is not in use for supporting a wheel of the vehicle. The present invention addresses these and other needs.

### SUMMARY OF THE INVENTION

Briefly, and in general terms, the present invention provides for a load distributing arrangement which includes a load distributing means of the type described. In one presently preferred embodiment, the load distributing means is configured to define a running board for a vehicle, and a mounting means is provided for removably mounting the load distributing means in position on the vehicle so that the load distributing means serves as a running board, in use.

The load distributing means may be formed from a plurality of steel channel sections attached to one another in a side-by-side relation. Abutting sides of adjacent channel sections may be welded to one another. The sides of the channel sections may thus form reinforcing ribs to inhibit deformation of the load distributing means, in use. In particular, the ribs may inhibit deformation of the channel sections in a plane defined through a longitudinal axis of the load distributing means and perpendicular thereto.

The channel sections may be of a perforated steel plate. Then the perforations may inhibit slipping of persons standing on the load distributing means, when in its application as a running board. The perforations may also provide purchase for tires of a vehicle, when the load distributing means is used in its application as a sand ladder.

The mounting means may include a steel frame which may be bolted to the chassis of the vehicle and may extend laterally from the vehicle body define a platform for supporting the load distributing means. The mounting means may further include releasable fastening means, by means of which the channel sections may be attached to the frame, with the ribs of the channel sections oriented downwards. The releasable fastening means may comprise releasable clips. Then, when clipped in place, the channel sections may define a substantially planar perforated surface to act as a running board for the vehicle. The load distributing means may be easily removed from the frame, when required, and used as a sand ladder. Thereafter, the load distributing means may be clipped in place on the frame

A fascia may be attached to a free end of the frame, the fascia extending along, and parallel to, a side of the vehicle to which the frame is attached. The fascia may be configured to cover an operatively outer edge of the load distributing means, to provide an aesthetically pleasing finish for the load distributing arrangement. Further, a mud flap, or mud flaps, may be attached to either one or both front and rear facing ends of the frame.

These and other aspects and advantages of the invention will become apparent from the following detailed description and the accompanying drawings, which illustrate by way of example the features of the invention.

### BRIEF DESCRIPTION OF THE DRAWINGS

FIG. 1 shows an end view of a load distributing arrangement in accordance with the invention, mounted on a vehicle;

FIG. 2 shows a detail of a side view of the load distributing arrangement;

FIG. 3 shows a plan view of a load distributing means of the invention;

FIG. 4 shows a side view of the load distributing means;

FIG. 5 shows a sectional end view of the load distributing means through a Section B on FIG. 3;

FIG. 6 shows a top view of a frame of a mounting means of the load distributing arrangement;

FIG. 7 shows a side view of the frame;

FIG. 8 shows a side view of the load distributing arrangement in use; and

FIG. 9 shows a further side view of the load distributing arrangement in use.

### DETAILED DESCRIPTION OF THE PREFERRED EMBODIMENTS

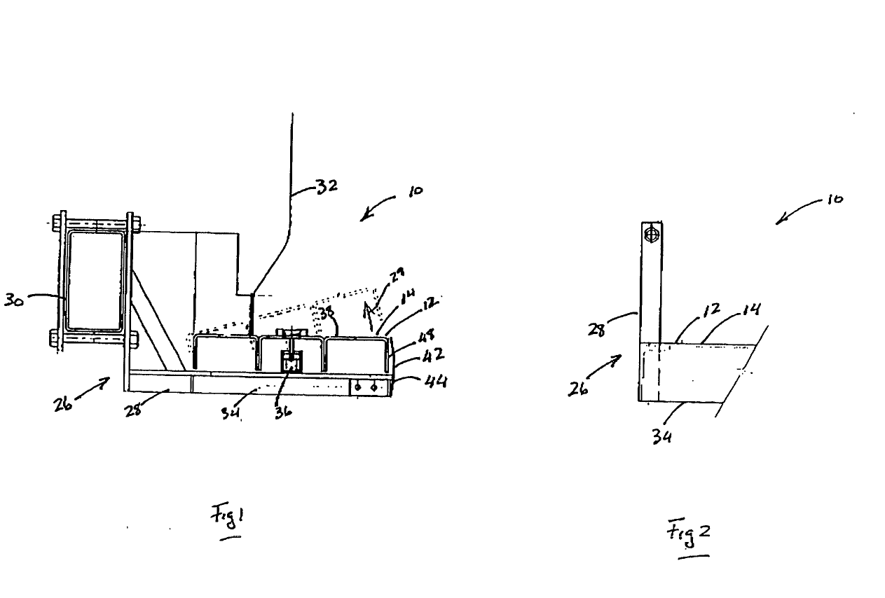

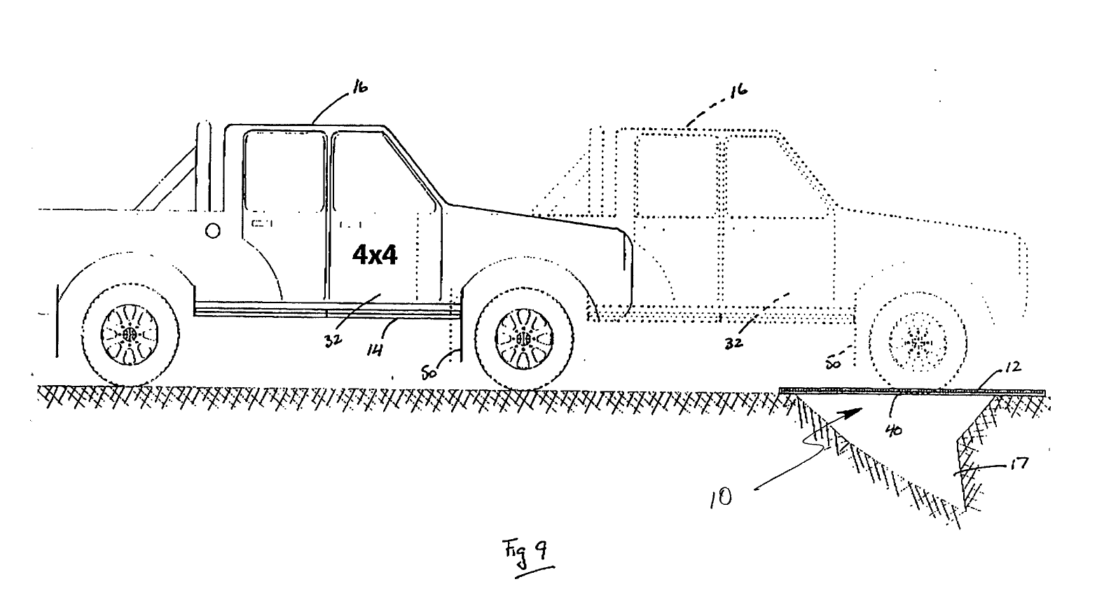

As is illustrated in the drawings, the invention is embodied in a load distributing arrangement. With reference to FIGS. 1, 8 and 9, reference numeral 10 generally indicates a load distributing arrangement in accordance with the invention. The load distributing arrangement 10 includes a load distributing means 12 which is configured to define a running board 14 for a vehicle 16 that can be utilized for supporting a wheel 17 of a vehicle, as is shown in FIGS. 8 and 9.

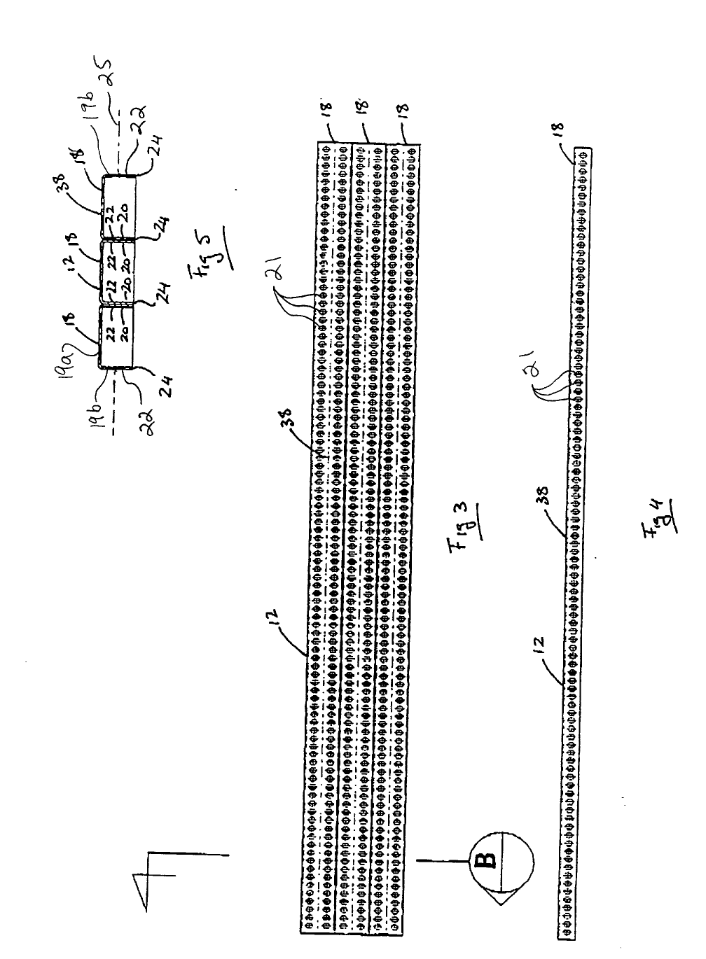

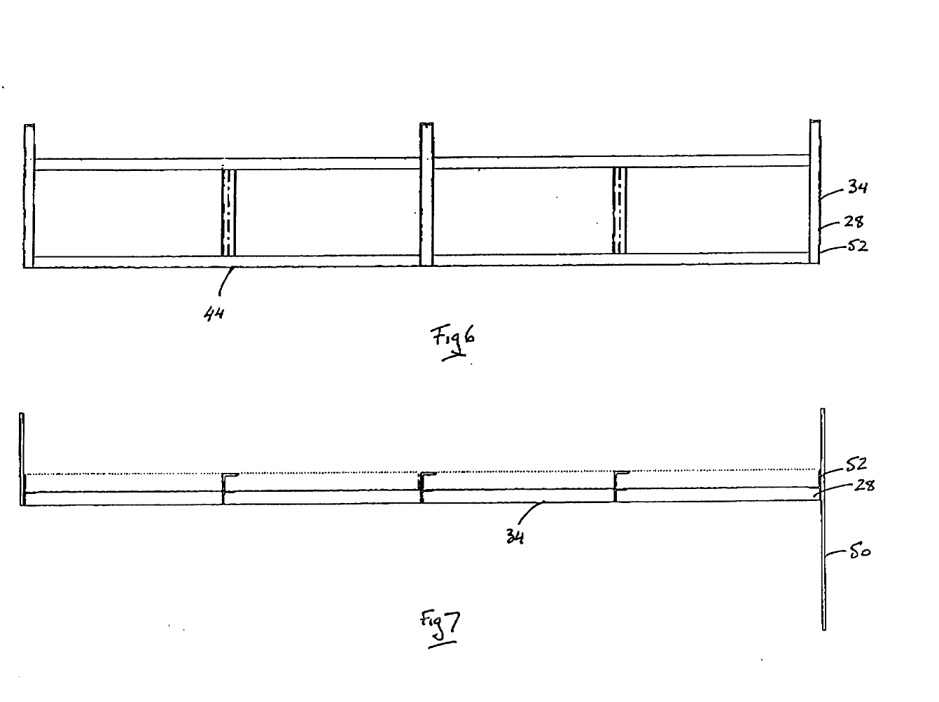

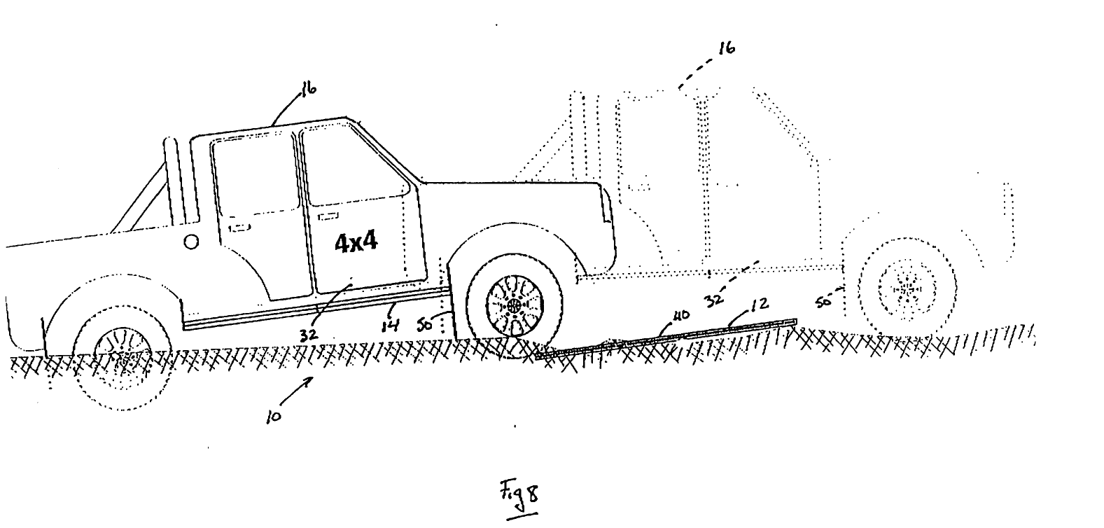

Referring to FIGS. 3, 4 and 5, in a presently preferred embodiment, the load distributing means 12 comprises a planar member formed from a plurality of U-shaped, longitudinal channel sections 18 each having a planar middle portion 19a, and a pair of side portions 19b extending in a common direction at right angles from the middle portion. In a presently preferred embodiment, the load distributing means is formed by three stainless steel channel sections 18 which are attached to one another in a side-by-side relation, as shown in FIGS. 3, 4 and 5. Abutting sides 20 of adjacent channel sections 18 are welded to one another. Referring to FIGS. 3 and 4, the channel sections 18 have a surface 38 defining a plurality of perforations 21 therein to provide a substantially planar perforated surface. Thus, when clipped in place on the vehicle, as shown in FIG. 1, the channel sections 18 define a substantially planar perforated surface 38 to define a running board 14 for the vehicle 16. Sides 22 of the channel sections 18 form reinforcing ribs 24 to inhibit the deformation of the surface 38, in use. In particular, the ribs 24 inhibit deformation of the channel sections 18 about a lateral axis 25 of the channel sections 18, as shown in FIG. 5. The channel sections 18 are preferably formed of perforated stainless steel plate.

The load distributing arrangement 10 further includes a mounting means 26 for removably mounting the load distributing means 12 to a vehicle to serve as a running board. The mounting means 26 includes a steel frame 28 which is bolted to the chassis 30 of the vehicle 16, as shown in FIG. 1. Referring to FIGS. 1 and 2, the steel frame 28 extends laterally from the vehicle body 32 to define a platform 34 for supporting the channel sections 18 of the load distributing means 12. The mounting means 26 further includes one or more releasable clips 36 by means of which the load distributing means 12 is attached to the frame 28, with the ribs 24 of the channel sections 18 being oriented downwards.

The conjoined channel sections 18 forming the load distributing means 12 may be easily removed from the frame 28, when required, and used as sand ladder 40, as shown in the FIGS. 8 and 9. Thereafter, the conjoined channel sections 18 may again be clipped in place on the frame 28. FIG. 1 shows, in broken lines, the conjoined channel sections 18 in the process of removal from the frame 28, with the arrow 29 indicating the direction in which the channel sections 18 are moved for removal thereof.

A fascia 42 optionally may also be attached to a free end 44 of the frame 28, the fascia 42 extending along, and parallel to, a side of the vehicle 16. The fascia 44 is configured to cover an operatively outward edge 48 of the conjoined channel sections 18, to provide an aesthetically pleasing finish to the load distributing arrangement 10. Further, one or more mud flaps 50 optionally may be attached to a front-facing end 52 of the frame 28.

The invention thus provides a load distributing arrangement 10 which enables the combination of a running board 14 and a sand ladder 40. The problems associated with the storage of sand ladders 40 is obviated, since they may serve as running boards 14 or the vehicle 16. It will be appreciated that where off-road vehicles (also known as “4×4 vehicles”), are used in rough conditions where loose sand or mud may be encountered, both running boards and sand ladders are commonly employed on the vehicle 16. On encountering loose sand or mud, the load distributing means of the invention may be dismounted from the frame 28 and used as a sand ladder 40 for distributing the load of the vehicle 16 to enable extrication of the vehicle 16 from loose sand or mud, as shown in FIG. 8, or to enable the vehicle 16 to traverse a trough 17, as shown in FIG. 9.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A load distributing arrangement for supporting a wheel of a vehicle, comprising:
a plurality of U-shaped, longitudinal channel sections each having a planar middle portion and a pair of side portions extending in a common direction at right angles from the middle portion, adjacent side portions of said plurality of U-shaped, longitudinal channel sections being attached to one another in side-by-side relation, the attached adjacent side portions of the channel sections forming reinforcing ribs to inhibit deformation of the U-shaped, longitudinal channel sections in a plane defined through a longitudinal axis of the load distributing means and perpendicular thereto.

2. The load distributing arrangement of claim 1, wherein said plurality of U-shaped, longitudinal channel sections are formed from steel plate.

3. The load distributing arrangement of claim 1, wherein said U-shaped, longitudinal channel sections have a surface defining a plurality of perforations therein.

4. The load distributing arrangement of claim 1, wherein abutting sides of adjacent channel sections are welded to one another.

5. The load distributing arrangement of claim 1, further comprising a mounting assembly for removably mounting the plurality of U-shaped, longitudinal channel sections to a vehicle to serve as a running board, whereby the plurality of U-shaped, longitudinal channel sections can be removed from the vehicle for use in supporting a wheel of the vehicle.

6. The load distributing arrangement of claim 5, wherein said mounting assembly comprises:
a mounting frame secured to a chassis of the vehicle to extend laterally from the vehicle to define a platform for supporting the plurality of U-shaped, longitudinal channel sections; and
means for releasably fastening the plurality of U-shaped, longitudinal channel sections to the mounting frame, by means of which the channel sections may be attached to the frame, with the ribs of the channel sections orientated downwards.

7. The load distributing arrangement of claim 6, wherein said means for releasably fastening the plurality of U-shaped, longitudinal channel sections comprises at least one releasable clip.

8. The load distributing arrangement of claim 6, further comprising a fascia attached to a free end of the mounting frame, the fascia extending along, and parallel to, a side of the vehicle to which the frame is attached.

9. The load distributing arrangement of claim 6, further comprising at least one mud flap attached to an end of the mounting frame.

10. A load distributing arrangement for a vehicle, comprising:
a load distributing planar member; and
a mounting assembly for removably mounting the load distributing planar member to a vehicle to serve as a running board, whereby the load distributing planar member can be removed from the vehicle for use in supporting a wheel of the vehicle.

11. The load distributing arrangement of claim 10, wherein said load distributing planar member comprises a plurality of U-shaped, longitudinal channel sections each having a planar middle portion and a pair of side portions extending in a common direction at right angles from the middle portion, adjacent side portions of said plurality of U-shaped, longitudinal channel sections being attached to one another in side-by-side relation, the attached adjacent side portions of the channel sections forming reinforcing ribs to inhibit deformation of the U-shaped, longitudinal channel sections in a plane defined through a longitudinal axis of the load distributing means and perpendicular thereto.

12. The load distributing arrangement of claim 10, wherein said mounting assembly comprises:
a mounting frame secured to a chassis of the vehicle to extend laterally from the vehicle to define a platform for supporting the load distributing planar member; and
means for releasably fastening the load distributing planar member to the mounting frame, by means of which the channel sections may be attached to the frame, with the ribs of the channel sections orientated downwards.

13. The load distributing arrangement of claim 12, wherein said means for releasably fastening the load distributing planar member comprises at least one releasable clip.

14. The load distributing arrangement of claim 12, further comprising a fascia attached to a free end of the mounting frame, the fascia extending along, and parallel to, a side of the vehicle to which the frame is attached.

15. The load distributing arrangement of claim 12, further comprising at least one mud flap attached to an end of the mounting frame.

16. The load distributing arrangement of claim 11, wherein said plurality of U-shaped, longitudinal channel sections are formed from steel plate.

17. The load distributing arrangement of claim 11, wherein said U-shaped, longitudinal channel sections have a surface defining a plurality of perforations therein.

18. The load distributing arrangement of claim 11, wherein abutting sides of adjacent channel sections are welded to one another.

19. A load distributing arrangement for a vehicle, comprising:
a load distributing means for supporting a wheel of a vehicle; and
a mounting means for removably mounting the load distributing means to a vehicle to serve as a running board, whereby the load distributing means can be removed from the vehicle for use in supporting a wheel of the vehicle.

20. The load distributing arrangement of claim 19, wherein said load distributing means comprises a plurality of U-shaped, longitudinal channel sections each having a planar middle portion and a pair of side portions extending in a common direction at right angles from the middle portion, adjacent side portions of said plurality of U-shaped, longitudinal channel sections being attached to one another in side-by-side relation, the attached adjacent side portions of the channel sections forming reinforcing ribs to inhibit deformation of the U-shaped, longitudinal channel sections in a plane defined through a longitudinal axis of the load distributing means and perpendicular thereto.

21. The load distributing arrangement of claim 19, wherein said mounting means comprises:
a mounting frame secured to a chassis of the vehicle to extend laterally from the vehicle to define a platform for supporting the load distributing means; and
means for releasably fastening the load distributing means to the mounting frame, by means of which the channel sections may be attached to the frame, with the ribs of the channel sections orientated downwards.

22. The load distributing arrangement of claim 21, wherein said means for releasably fastening the load distributing means comprises at least one releasable clip.

23. The load distributing arrangement of claim 21, further comprising a fascia attached to a free end of the mounting frame, the fascia extending along, and parallel to, a side of the vehicle to which the frame is attached.

24. The load distributing arrangement of claim 21, further comprising at least one mud flap attached to an end of the mounting frame.

25. The load distributing arrangement of claim 20, wherein said plurality of U-shaped, longitudinal channel sections are formed from steel plate.

26. The load distributing arrangement of claim 20, wherein said U-shaped, longitudinal channel sections have a surface defining a plurality of perforations therein.

27. The load distributing arrangement of claim 20, wherein abutting sides of adjacent channel sections are welded to one another.
